(19) United States
(12) Patent Application Publication
(10) Pub. No.: US 2015/0000141 A1
(43) Pub. Date: Jan. 1, 2015

(54) Wire Sheet Cake Cutter

(71) Applicant: Michael Owens, Nome, AK (US)

(72) Inventor: Michael Owens, Nome, AK (US)

(21) Appl. No.: 14/226,924

(22) Filed: Mar. 27, 2014

Related U.S. Application Data
(60) Provisional application No. 61/840,498, filed on Jun. 28, 2013.

(51) Int. Cl. A21C 15/04

(52) U.S. Cl. CPC A21C 15/04
USPC 30/114

(57) ABSTRACT

A sheet cake cutter is provided. The present cake cutter comprises a rectangular frame with a plurality of cutting wires extending between opposing sides of the perimeter of the frame, creating a plurality of rectangular openings. The cake cutter is placed over a cake and then force is applied, pushing the wires of the device through the body of the cake. The present invention saves users substantial amount of time by cutting an entire cake at once, as opposed to cutting pieces of cake individually, and produces aesthetically pleasing and uniform pieces of cake. The tension of the cutting wires is freely adjustable in order to preserve the lifespan of the wire and to ensure a smooth cut with each use.

### CROSS REFERENCE TO RELATED APPLICATION

This application claims the benefit of U.S. Provisional Application No. 61/840,498 filed on Jun. 28, 2013, entitled “Sheet Cake Cutter.” The above identified patent application is herein incorporated by reference in its entirety to provide continuity of disclosure.

### BACKGROUND OF THE INVENTION

1. Field of the Invention

The present invention relates to cake cutters. Specifically, the present invention relates to cake cutters having a frame with a plurality of wires or blades disposed between the sides of said frame.

Cutting large numbers of individual slices from a sheet cake is a very laborious, time-consuming, and inexact process. It is quite difficult to ensure that every single piece of cake is precisely the same size. If customers get especially small pieces of cake they may complain and the food provider may be forced to discard the slices of cake, resulting in highly undesirable waste. Larger than intended pieces also cost the food provider money because they are giving away too much for their intended price point. Therefore, there is a huge need for fast and efficient ways to cut uniform slices from a sheet cake.

Current cake cutting devices generally consist of a plurality of blades or wires disposed between opposing sides of a frame to create a grid-like pattern. Cake cutting devices using blades are generally undesirable because blades have a higher cutting surface area than wires, meaning that they cause more ripping or tearing of the delicate cake and have a tendency to take portions of frosting or cake with them when they are removed. Wires, on the other hand, have a very small surface area, so they can create very smooth cuts and have a better tendency to leave to cake fully intact when withdrawn. However, wires can lose tension over time, which results in less smooth cuts and necessitates their removal.

The present wire sheet cake cutter provides a means for adjusting the tension of the cutting wires or removing them entirely to be replaced, if necessary. The means for adjusting the tension of the wires prolongs the lifespan of the cutting wires because they can merely be tightened, rather than completely replaced, if they become loose and are no longer producing smooth cuts. Every wire can be individually tightened so that it is no longer necessary to replace an entire sheet cake cutting device when merely one wire is no longer performing adequately.

2. Description of the Prior Art

Devices have been disclosed in the prior art that relate to wire cutters. These include devices that have been patented and published in patent application publications. These devices generally relate to wires suspended between opposing sides of a frame. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 492,417 to McAlister, which describes a cake cutter having a frame and a plurality of blades disposed between opposing sides of the frame. This invention provides quicker means for cutting sections of cake, but it only has blades extending in a single direction, thus it is impossible to cut appropriately-sized pieces of cake with a single use of the device. Instead, it would be necessary to use the device to cut the cake in one direction, then rotate it 90 degrees and use the device again, to get appropriately-sized slices of cake. Furthermore, McAlister uses blades as its cutting edges, whereas the present invention uses taut wires.

Another such device is U.S. Pat. No. 2,403,190 to Parraga, which discloses a cake cutter designed for circular cakes. Parraga comprises a circular frame that has a plurality of cutting wires crisscrossing the open interior of the frame to create equally sized cut-out regions. The present invention also utilizes cutting wires suspended between the walls of its frame, but the present invention has a tightening mechanism for ensuring that the cutting wires remain taut at all times, which improves the lifespan of the device.

U.S. Pat. No. 4,195,402 to Leffer is another such device and discloses a dessert cutter for cakes and other such confections. Leffer comprises a frame with a plurality of wires stretched therebetween in both directions and at least one of the cutting wires is slidably adjustable along the frame so the device can cut pieces of different sizes. The cutting wires of the present invention are also adjustable, but their tautness is adjustable, rather than their position along the frame. The adjustability of the present invention's cutting wires extends the lifespan of the device and does not change the dimensions of the pieces of cake that the device cuts.

Another such device is U.S. Pat. No. 4,213,241 to Haapala, which discloses a cake layer cutter. Haapala comprises a U-shaped member with a wire extending between the ends of the arms of the device. The device is intended to cut horizontally through a cake in order to split it into two halves in order to place icing between the two layers. The present invention has a plurality of cutting wires rather than a single wire and is designed to cut a cake into a plurality of pieces through vertical cuts, rather than horizontal cuts. Furthermore, Haapala does not provide a means for re-tensioning the wires to ensure that the cutting wires remain taut.

Finally, U.S. Published Patent Application Publication No. 2004/0211069 to Tuttle discloses a cake cutter that has a plurality of blades that crisscross between a frame, thereby cutting a cake into a plurality of pieces of substantially the same size when pressure is applied to push the device downwards through the cake. The Tuttle device additionally includes a detachable handle portion for applying force to the cake cutter. The present invention optionally includes handles, but they are not removable and are disposed along the perimeter of the frame and not on the cutting surfaces themselves. Additionally, the present invention utilizes wires, rather than blades, as its cutting surfaces.

The present cake sheet cutter provides a new and novel cake cutting device that has removable and adjustable tensioned cutting wires. The tension of the cutting wires can be adjusted as needed in order to ensure that the device cuts crisp pieces and prolong the lifespan of the device. It substantially diverges in design elements from the prior art and consequently it is clear that there is a need in the art for an improvement to existing cake cutting devices. In this regard the instant invention substantially fulfills these needs.

### SUMMARY OF THE INVENTION

In view of the foregoing disadvantages inherent in the known types of cake cutters now present in the prior art, the present invention provides a new wire sheet cake cutter wherein the same can be utilized for providing convenience for the user when cutting a cake into a plurality of uniform slices.

It is therefore an object of the present invention to provide a new and improved sheet cake cutting device that has all of the advantages of the prior art and none of the disadvantages.

It is another object of the present invention to provide a sheet cake cutting device that uses wires as its cutting surface.

Another object of the present invention is to provide a sheet cake cutting device that has removable cutting wires.

Yet another object of the present invention is to provide a sheet cake cutting device that has tensioning adjusting means for adjusting the tension of the cutting wires.

Yet another object of the present invention is to provide a sheet cake cutting device that quickly and easily slices a cake into a plurality of uniform slices.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the preferred embodiment of the present invention, along with a call out highlighting the removable fasteners and the tensioning means.

FIG. 2 shows a perspective view of the preferred embodiment of the present invention in use cutting a rectangular cake.

### DETAILED DESCRIPTION OF THE INVENTION

Reference is made herein to the attached drawings. Like reference numerals are used throughout the drawings to depict like or similar elements of the wire sheet cake cutter. For the purposes of presenting a brief and clear description of the present invention, the preferred embodiment will be discussed as used for cutting a rectangular cake into a plurality of uniform slices. The figures are intended for representative purposes only and should not be considered to be limiting in any respect.

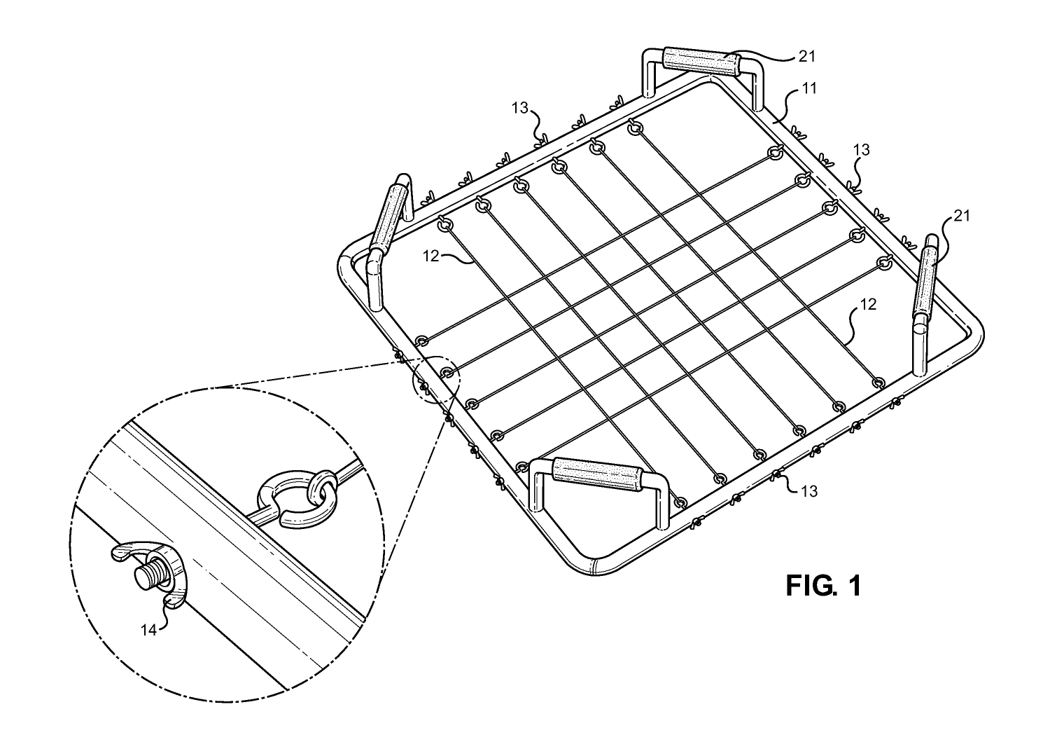

Referring now to FIG. 1, there is shown a perspective view of the preferred embodiment of the present invention. The present wire sheet cake cutter comprises a frame 11 that may be arranged in a rectangular shape, circular shape, or any other shape that can correspond to the shape of a cake. As depicted, the present frame 11 is configured to have four sides arranged in a rectangular shape suitable for cutting rectangularly-shaped cakes. A rectangular embodiment of the present invention is designed to cut rectangular cakes, a circular embodiment of the present invention is designed to cut circular cakes, and so on. The frame 11 may come in various sizes in order to uniformly cut a variety of sized cakes. The frame 11 is made of copper, stainless steel, or any other suitable material and is generally tubular.

A plurality of tensioning means 13 are disposed along the inside face of the perimeter of the frame. Said tensioning means 13 are evenly spaced along each side of the frame 11 and are aligned with corresponding tensioning means 13 on the opposing side of the frame 11. A plurality of cutting wires 12 are disposed between the sides of the frame 11, with each cutting wire 12 attached to, and extending between, an opposing pair of corresponding tensioning means 13. The cutting wires 12 extending across the interior of the frame crisscross each other to create a plurality of uniformly-sized cutout regions. The cutting wires 12 may be composed of carbon steel, stainless steel, or any other material that has sufficient hardness. The cutout regions, as depicted, are rectangular, but no claim is made as to the precise size and shape of the cutout regions. In the depicted embodiment, the tensioning means 13 are depicted as hook screws that are removably disposed through a threaded aperture and are held in place by a wing nut 14, but said tensioning means 13 may be any fastening means that are both suitable for removably holding the cutting wires 12 in place and that allows for the tautness of the wires to be adjusted.

The tensioning means 13 are individually connected to each of the cutting wires 12, allowing the cutting wires 12 to be individually tightened and untightened. Loose cutting wires 12 are less effective at making smooth cuts, so it is to a user's advantage to be able to tighten said cutting wires 12 instead of being forced to either replace the wire or replace the entire device. The wing nuts 14 of the depicted embodiment are threadably disposed on the hook screws along the exterior face of the frame 11. The user tightens the cutting wires 12 by tightening the wing nuts, which draws more of the threaded portion of the hook screws through the exterior face of the frame 11 and thereby tightens the cutting wires 12 by decreasing the distance between opposing tensioning means 13. However, the tensioning means 13 may comprise any means capable tightening or loosening the cutting wires 12 connected to the tensioning means 13. The cutting wires 12 may be composed of a variety of different materials, but must be held tightly enough by the tensioning means 13 in order to adequately and smoothly cut the cake.

The present wire sheet cake cutter may additionally have a plurality of handles 21 disposed along the frame 11. In the preferred embodiment there are four handles 21 disposed across the corners of the rectangular frame 11. The handles 21 make the present device easier to pick up and place in position, but mostly provide a more comfortable base for a user to apply downward force to when cutting a cake. The handles 21 may come with grips or without grips and may be of any suitable size.

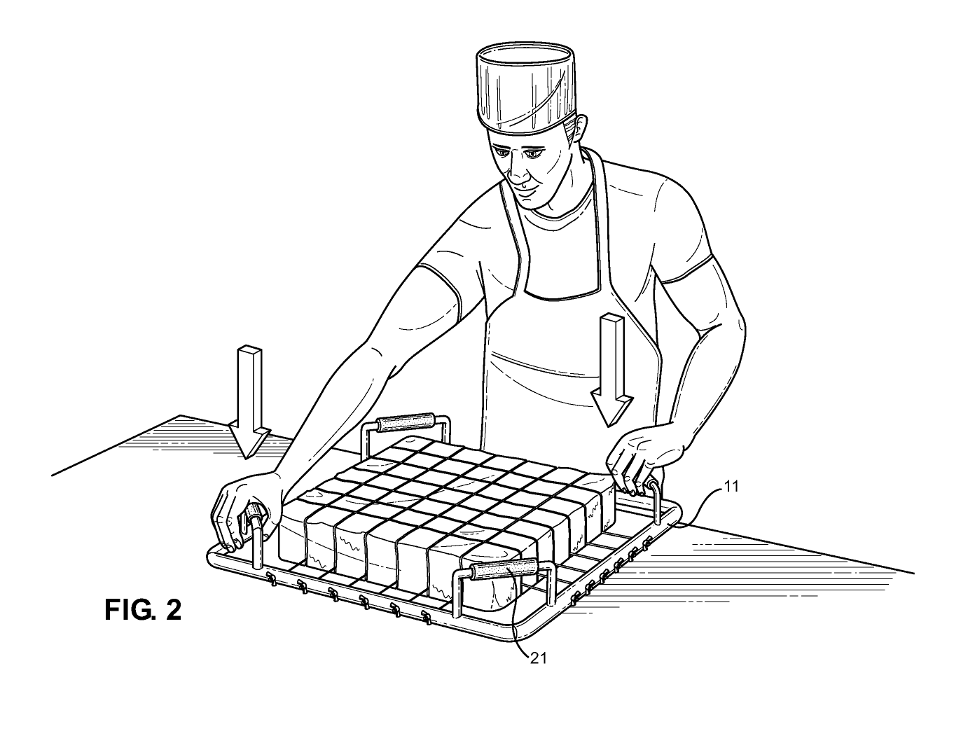

Referring now to FIG. 2, there is shown a perspective view of the preferred embodiment of the present invention in use. In use, the preferred embodiment of the present wire sheet cake cutter is placed in position over a cooled sheet cake and positioned so that the present invention will cut uniform pieces out of the cake. The user then, while holding the handles, applies a downward forced sufficient to completely cut through the cake. The user then withdraws the present invention back up through the cuts that were just made and the cake is ready to serve as it has been sliced into a plurality of uniformly sized pieces.

Overall, the present wire sheet cake cutter provides a new and novel means for cutting cakes. The prior art does not disclose a sheet cake cutter having removable wires and tightening means securing said wires. Said tightening means prolongs the lifespan of the individual cutting wires and the device as a whole, because previously once a wire became loose due to wear, either the wire or the entire device had to be replaced. The tightening means provided in the present invention instead permits the individual wires to be merely tightened, rather than replaced, ensuring that the present invention will continue to produce smooth cuts, and thus neat, uniform slices of cake, for a much longer period of time than traditional wire cake cutters.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A cake sheet cutter, comprising:
a frame having a plurality of sides arranged to form a closed loop;
a plurality of cutting wires extending between opposing sides of said frame and overlapping to form a plurality of uniformly shaped cutout regions;
a plurality of tensioning means attaching said cutting wires to said frame and adapted to adjust the tautness of said cutting wires.

2. A cake sheet cutter, comprising:
a frame having a pair of opposing sides forming a rectangular shape;
a plurality of cutting wires extending between opposing sides of said frame and overlapping to form a plurality of uniformly shaped rectangular cutout regions;
a plurality of tensioning means attaching said cutting wires to said frame and adapted to adjust the tautness of said cutting wires.

3. The cake sheet cutter of claim 1, further comprising a plurality of handles disposed along said frame.

4. The cake sheet cutter of claim 2, further comprising a plurality of handles disposed along said frame.

5. The cake sheet cutter of claim 4, wherein said handles number four and are disposed across the corners of said frame.
